(19) United States
(12) Patent Application Publication
(10) Pub. No.: US 2016/0185261 A1
(43) Pub. Date: Jun. 30, 2016

(54) VEHICLE SEAT

(71) Applicant: JOHNSON CONTROLS COMPONENTS GMBH & CO. KG, Kaiserlautern (DE)

(72) Inventors: Heinrich HAMMANN, Teschenmoschel (DE); Wolfgang PLUTA, Heiligenmoschel (DE); Thomas DILL, Heiligenmoschel (DE); Viktor ENNS, Kaiserslautern (DE)

(21) Appl. No.: 14/650,722

(22) PCT Filed: Dec. 4, 2013
(86) PCT No.: PCT/EP2013/075507

§ 371 Date: Jun. 9, 2015

(30) Foreign Application Priority Data
Dec. 10, 2012 (DE) 10 2012 024 499.1
Feb. 27, 2013 (DE) 10 2013 003 789.1

(51) Int. Cl. B60N 2/235; B60N 2/68

(52) U.S. Cl. CPC B60N 2/235; B60N 2/686; B60N 2/682

(57) ABSTRACT

A vehicle seat (1) has a seat segment (14) with a first seat (11) having a first backrest (21) and a second seat (12) having a second backrest (22) and a seat part (24). The first backrest and the second backrest are pivotable about a pivot axis (A) relative to the seat part. A first fitting (51) and a second fitting (52) connect the first backrest to the seat part. The fittings (51, 52) each have a fitting part fixed to the seat part and a fitting part fixed to the backrest that are pivotable relative to one another. The second backrest is pivotable about the pivot axis (A) via a first rotary bearing point (71) that is a fixed bearing and via a second rotary bearing part (72) that is a floating bearing. The second rotary bearing point includes a rotary bearing sleeve (54) mounted on the first fitting.

### CROSS REFERENCE TO RELATED APPLICATIONS

This application is a United States National Phase Application of International Application PCT/EP2013/075507 filed Dec. 4, 2013 and claims the benefit of priority under 35 U.S.C. §119 of German Patent Applications DE 10 2012 024 499.1 filed Dec. 10, 2012 and DE 10 2013 003 789.1 filed Feb. 27, 2103, the entire contents of which are incorporated herein by reference.

### FIELD OF THE INVENTION

The invention relates to a vehicle seat having a seat segment which comprises a first seating position with a first backrest and a second seating position with a second backrest and a seat part, it being possible for the first backrest and the second backrest to be pivoted about a pivot axis relative to the seat part, and the first backrest being connected to the seat part by means of a first fitting and a second fitting, the fittings in each case having a fitting part which is fixed to the seat part and a fitting part which is fixed to the backrest, which fitting parts can be pivoted relative to one another.

### BACKGROUND OF THE INVENTION

DE 10 2007 011 874 A1 has disclosed a vehicle seat of the generic type. The vehicle seat which is configured as a rear seat comprises two seat segments, one of the seat segments comprising one seating position and the other seat segment comprising two seating positions. The two seat segments are arranged next to one another and can be displaced in the driving direction by means of longitudinal adjusters independently of one another.

The pivotable backrest is attached to the seat segment which comprises one seating position. Two backrests which are arranged next to one another are attached to the seat segment which comprises two seating positions, which backrests can be pivoted about the same pivot axis relative to the seat segment.

DE 10 2005 043 084 A1 has disclosed a vehicle seat with two seat segments, to which in each case one or two backrests which can be pivoted about a pivot axis are attached.

DE 101 58 595 C1 discloses a backrest which is mounted by means of two pivot bearing points such that it can be pivoted about a pivot axis. In this case, one of the pivot bearing points is configured so as to be movable in the axial direction and is held without play by means of a spring.

### SUMMARY OF THE INVENTION

The invention is based on an object of improving a vehicle seat of the type mentioned at the outset, in particular of simplifying the mounting of the backrest which is arranged between the two other backrests.

A vehicle seat of the generic type has a seat segment which comprises a first seating location with a first backrest and a second seating location with a second backrest and a seat part, it being possible for the first backrest and the second backrest to be pivoted about a pivot axis relative to the seat part, and the first backrest being connected to the seat part by means of a first fitting and a second fitting, the fittings in each case having a fitting part which is fixed to the seat part and a fitting part which is fixed to the backrest, which fitting parts can be pivoted relative to one another.

According to the invention, the second backrest can be pivoted about the pivot axis by means of a first pivot bearing point which is configured as a locating bearing and by means of a second pivot bearing point which is configured as a floating bearing, the second pivot bearing point comprising a pivot bearing sleeve which is fastened to the first fitting.

As a result, simple mounting of the second backrest is possible, even if it is already upholstered. The first fitting of the first backrest therefore also forms the second pivot bearing point and therefore performs a double function.

During mounting, the second backrest can be moved in the direction of the first backrest which has already been mounted in an inclined manner relative to the vertical direction and/or relative to the longitudinal direction, and can first of all be pushed with said inclined orientation onto the second pivot bearing point which is configured as a floating bearing. Subsequently, the second backrest can then be tilted into its end position and the first pivot bearing point which is configured as a locating bearing can be finished afterward, as a result of which the second backrest is then fixed.

According to one advantageous refinement of the invention, the first pivot bearing point comprises a fastening pin which engages through a lower part which is provided on the seat part and through a side part which is provided on the second backrest. As a result, the first pivot bearing point which is configured as a locating bearing can be produced comparatively simply during mounting, by the fastening pin being guided in the transverse direction through the lower part and the side part. The fastening pin is then preferably screwed to a pivot bearing opening of the side part.

Here, the pivot bearing sleeve is preferably fastened to that fitting part of the first fitting which is fixed on the seat part. However, it is also conceivable to fasten the pivot bearing sleeve to that fitting part of the first fitting which is fixed on the backrest.

The pivot bearing sleeve is advantageously configured in the form of a hollow cylinder. A hollow cylinder of this type can be fastened, preferably welded, to the fitting part, a free space remaining in the interior of the hollow cylinder, which free space receives, for example, a transmission rod for actuating the fitting.

Here, a cylinder axis which is defined by the pivot bearing pin is preferably aligned with the pivot axis.

According to one preferred refinement of the invention, a catching contour is attached to the pivot bearing sleeve, which catching contour prevents releasing of the second backrest from the pivot bearing sleeve in the case of a crash.

According to one advantageous development of the invention, the second pivot bearing point additionally comprises a pivot bearing pin. A pivot bearing pin of this type which has a comparatively small external diameter facilitates the introduction of the second backrest during mounting.

Here, the pivot bearing pin is particularly advantageously of rotationally symmetrical configuration. A cylinder axis which is defined by the pivot bearing pin is advantageously aligned with the pivot axis.

Here, the pivot bearing pin is preferably fastened to the first fitting. The pivot bearing pin is particularly advantageously fastened to the first fitting by means of an additional adapter, the additional adapter having a curvature, within which a free space remains for receiving a transmission rod for actuating the fitting.

According to a further advantageous refinement of the invention, the second pivot bearing point comprises a transmission rod for actuating the fitting, a two-piece bearing sleeve or a ball bearing being mounted on the transmission rod.

The fittings are preferably configured as latching fittings. However, it is also conceivable that the fittings are configured as gear mechanism fittings.

In the following text, the invention is explained in greater detail using one advantageous exemplary embodiment which is shown in the figures. However, the invention is not restricted to said exemplary embodiment. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a perspective illustration of a vehicle seat without upholstery;

FIG. 2 is a front view showing a first seat segment before mounting of the middle backrest;

FIG. 3 is a front view showing the first seat segment during mounting of the middle backrest;

FIG. 4 is a detailed view from FIG. 3;

FIG. 5 is a perspective illustration of the mounted middle backrest;

FIG. 6 is a front view showing the first seat segment after mounting of the middle backrest;

FIG. 7 is a perspective view showing a fitting with a pivot bearing sleeve; and

FIG. 8 is a perspective view of an alternative refinement of a pivot bearing point.

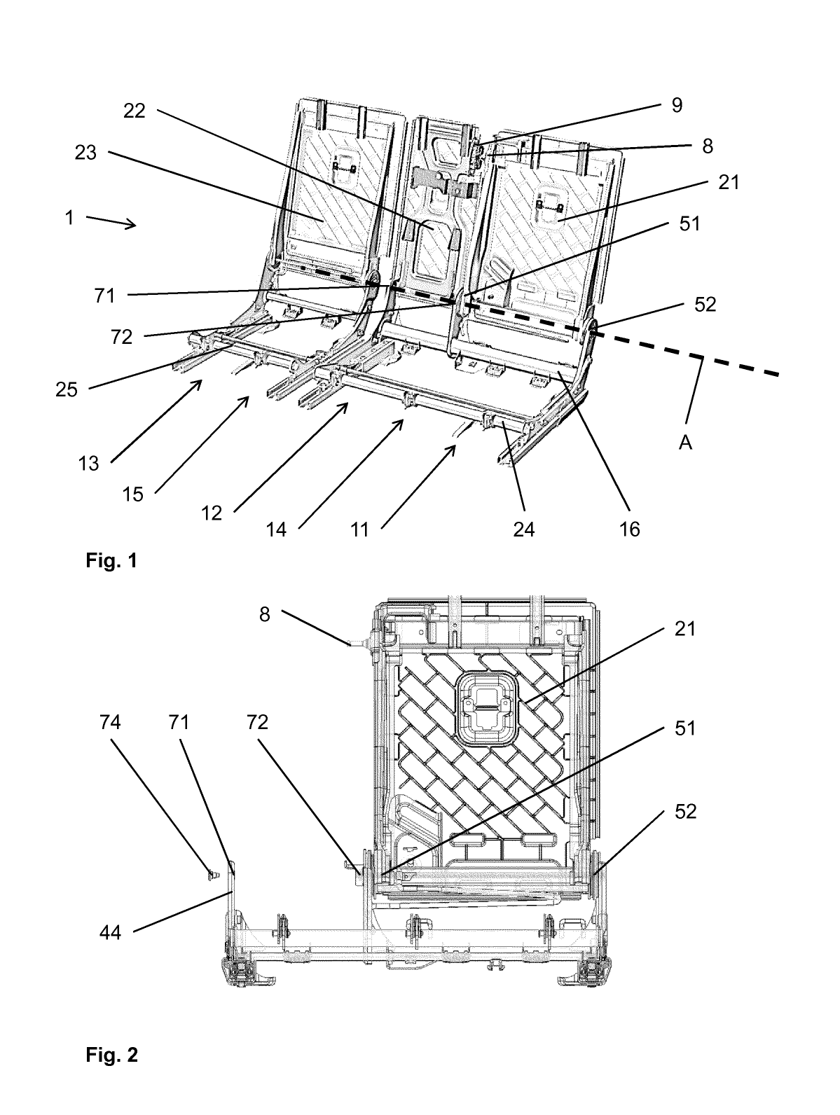

### DESCRIPTION OF THE PREFERRED EMBODIMENTS

A vehicle seat 1 is configured as a rear seat system of a motor vehicle. The vehicle seat 1 comprises a first seat segment 14 with a first seat part 24 and a second seat segment 15 with a second seat part 25 which are connected to the vehicle structure of the motor vehicle such that they can be adjusted longitudinally by means of longitudinal adjusters independently of one another.

The arrangement of the vehicle seat 1 within the vehicle and its usual driving direction define the directional specifications which are used in the following text. In this case, a direction which is oriented perpendicularly with respect to the ground is called a vertical direction in the following text and a direction perpendicular with respect to the vertical direction and perpendicular with respect to the driving direction is called a transverse direction in the following text. In the present case, the vertical direction also includes angles up to 30° with respect to the perpendicular and comprises, in particular, the orientation of the backrest of the vehicle seat 1 mounted in the vehicle in an upright use position.

The first seat segment 14 takes up approximately 60% of the entire width of the vehicle seat 1, whereas the second seat segment 15 takes up approximately 40% of said width. A first backrest 21 and a second backrest 22 are attached to the first seat part 24 such that they can be pivoted about a pivot axis A, whereas a third backrest 23 is attached pivotably to the second seat part 25.

In the present case, the first seat segment 14 with the first seat part 14 is arranged on the left-hand side in the driving direction and the second seat segment 15 with the second seat part 25 is arranged on the right-hand side in the driving direction. On account of their spatial arrangement, the first backrest 21 is called the left-hand backrest in the following text, the second backrest 22 is called the middle backrest and the third backrest 23 is called the right-hand backrest. In this case, the left-hand backrest 21 is arranged on the left-hand side in the driving direction and the right-hand backrest 23 is arranged on the right-hand side in the driving direction.

The middle backrest 22 is arranged between the left-hand backrest 21 and the right-hand backrest 23 in the transverse direction. The pivot axis A runs horizontally in the transverse direction.

Together with a part of the first seat part 24, the left-hand backrest 21 forms a first seating position 11. Together with a part of the first seat part 24, the middle backrest 22 forms a second seating position 12. Together with the second seat part 25, the right-hand backrest 23 forms a third seating position 13. The first seating position 11 and the second seating position 12 are assigned to the first seat segment 14, and the third seating position 13 is assigned to the second seat segment 15.

The seat parts 24, 25 and the backrests 21, 22, 23 are provided with upholstery in a manner which is known per se. The left-hand backrest 21 and the right-hand backrest 23 in each case take up approximately 40% of the entire width of the vehicle seat 1, whereas the middle backrest 22 takes up approximately 20% of said width.

The first seat part 24 comprises a transverse tube 16 which runs in the transverse direction parallel to the pivot axis A and extends approximately over the complete width of the first seat part 24.

The left-hand backrest 21 is connected to the transverse tube 16 of the first seat part 24 by means of a first fitting 51 which is arranged on the right-hand side in the driving direction and by means of a second fitting 52 which is arranged on the left-hand side in the driving direction. The left-hand backrest 21 can have its inclination relative to the first seat part 24 set firstly into different use positions by means of the fittings 51, 52 and secondly can be pivoted toward the front into a non-use position.

Instead of the second fitting 52, a single pivot bearing point can also be provided for mounting the left-hand backrest 21.

The second fitting 52 has a first fitting part which is connected fixedly to the first seat part 24, that is to say is fixed to the seat part, and a second fitting part which is connected fixedly to the left-hand backrest 21, that is to say is fixed to the backrest, which fitting parts can be pivoted relative to one another. In structural terms, the two fitting parts can form a disk-shaped unit and can be held together, for example, by way of a clasping ring.

In the present case, the second fitting 52 is configured as a latching fitting, that is to say the two fitting parts can be locked to one another by means of movable bolts. The bolts are moved into a blocking position, for example, by way of a spring-loaded eccentric. A fitting of this type is disclosed, for example, in DE 10 2011 010 699 A1, the disclosure content of which in this regard is expressly incorporated here.

The first fitting 51 is largely similar to the second fitting 52 and likewise has the above-described features and functions of the second fitting 52.

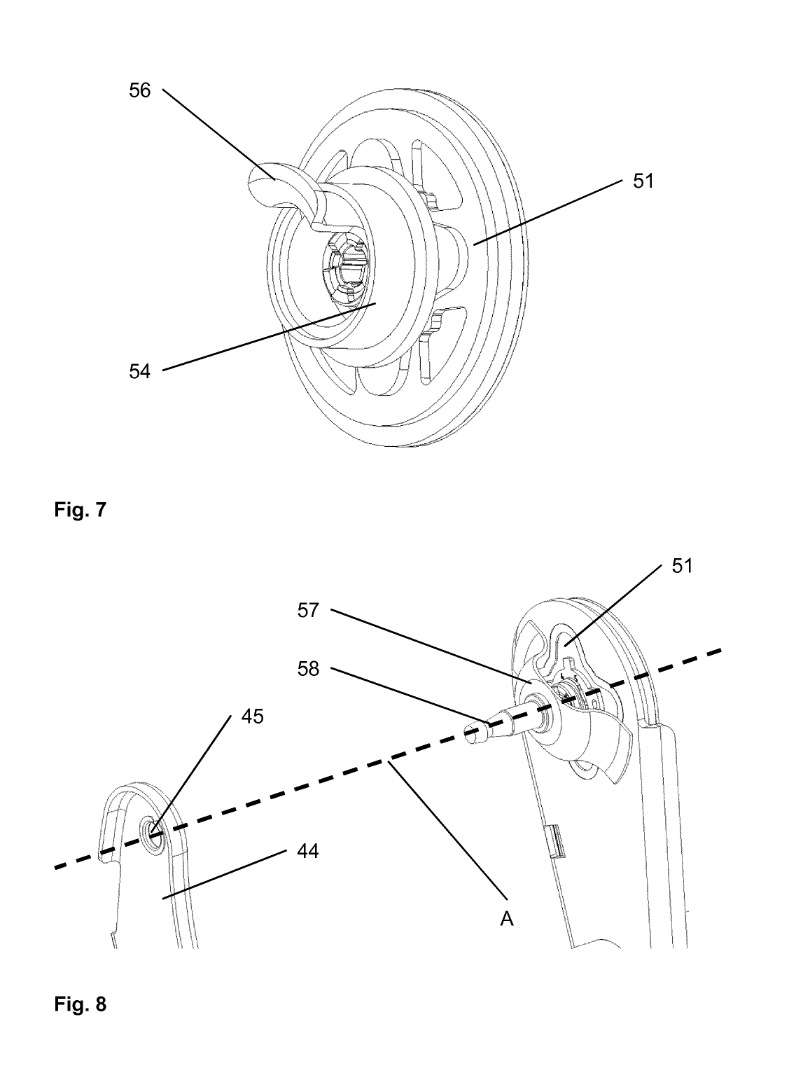

In addition, as shown in FIG. 7, the first fitting 51 has a pivot bearing sleeve 54 which is configured in the form of a hollow cylinder and is fastened to that fitting part of the first fitting 51 which is fixed on the seat part and faces away from the left-hand backrest 21. In this case, in the present case, the hollow-cylindrical pivot bearing sleeve 54 is welded to that fitting part of the first fitting 51 which is fixed on the seat part. The cylinder axis which is defined by the pivot bearing sleeve 54 is aligned with the pivot axis A.

A catching contour 56 is attached to the hollow-cylindrical pivot bearing sleeve 54, which catching contour 56 extends first of all in the axial direction from the pivot bearing sleeve 54, to be precise in the direction which faces away from the fitting 51, parallel to the pivot axis A, and protrudes to the outside in the radial direction at its end which faces away from the pivot bearing sleeve 54. In the present case, the catching contour 56 is configured in one piece with the pivot bearing sleeve 54.

The middle backrest 22 is connected to the transverse tube 16 of the first seat part 24 by means of a first pivot bearing point 71 which faces away from the left-hand backrest 21 and by means of a second pivot bearing point 72 which faces the left-hand backrest 21.

The first pivot bearing point 71 comprises a fastening pin 74 which has an external thread, and the center axis of which is aligned with the pivot axis A. The fastening pin 74 engages through a lower part 44 which is connected to the transverse tube 16 and through a first side part 31 which is provided on the middle backrest 22. To this end, the first side part 31 has a first pivot bearing opening 41 which is configured in the present case as a ball with an internal thread, and the internal diameter of which corresponds to the external diameter of the fastening pin 74. To this end, the lower part 44 has a through opening 45 which is likewise configured as a circular bore, and the internal diameter of which corresponds approximately to the external diameter of the fastening pin 74.

It is also conceivable to provide a sliding bush for mounting the fastening pin 74 in the through opening 45. In this case, the through opening 45 is adapted to the size of the sliding bush and is therefore larger than the external diameter of the fastening pin 74. Furthermore, the through opening 45 can also be elliptical or can be configured as a slot instead of being circular.

The second pivot bearing point 72 comprises the pivot bearing sleeve 54 which is fastened to the first fitting 51. In this case, the pivot bearing sleeve 54 penetrates a second side part 32 which is provided on the middle backrest 22. To this end, the second side part 32 has a second pivot bearing opening 42 which is configured in the present case as a circular bore, and the internal diameter of which corresponds approximately to the external diameter of the pivot bearing sleeve 54.

It is also conceivable to provide a sliding bush for mounting the second pivot bearing opening 42 on the pivot bearing sleeve 54. In this case, the pivot bearing opening 42 is adapted to the size of the sliding bush and is therefore larger than the external diameter of the pivot bearing sleeve 54. Furthermore, the second pivot bearing opening 42 can also be elliptical or can be configured as a slot instead of being circular.

The first pivot bearing point 71 is configured as a locating bearing. A displacement of the first side part 31 of the middle backrest 22 relative to the lower part 44 in the transverse direction is therefore not possible.

The second pivot bearing point 72 is configured as a floating bearing. A slight displacement of the second side part 32 of the middle backrest 22 relative to the pivot bearing sleeve 54 in the transverse direction is therefore possible, for example in order to compensate for tolerances.

In the case of a crash if the middle backrest 22 experiences an acceleration in the driving direction, a deformation of the second pivot bearing point 72 can take place, the second side part 32 being displaced relative to the pivot bearing sleeve 54 in the transverse direction. In this case, the catching contour 56 prevents the second side part 32 from being released from the pivot bearing sleeve 54.

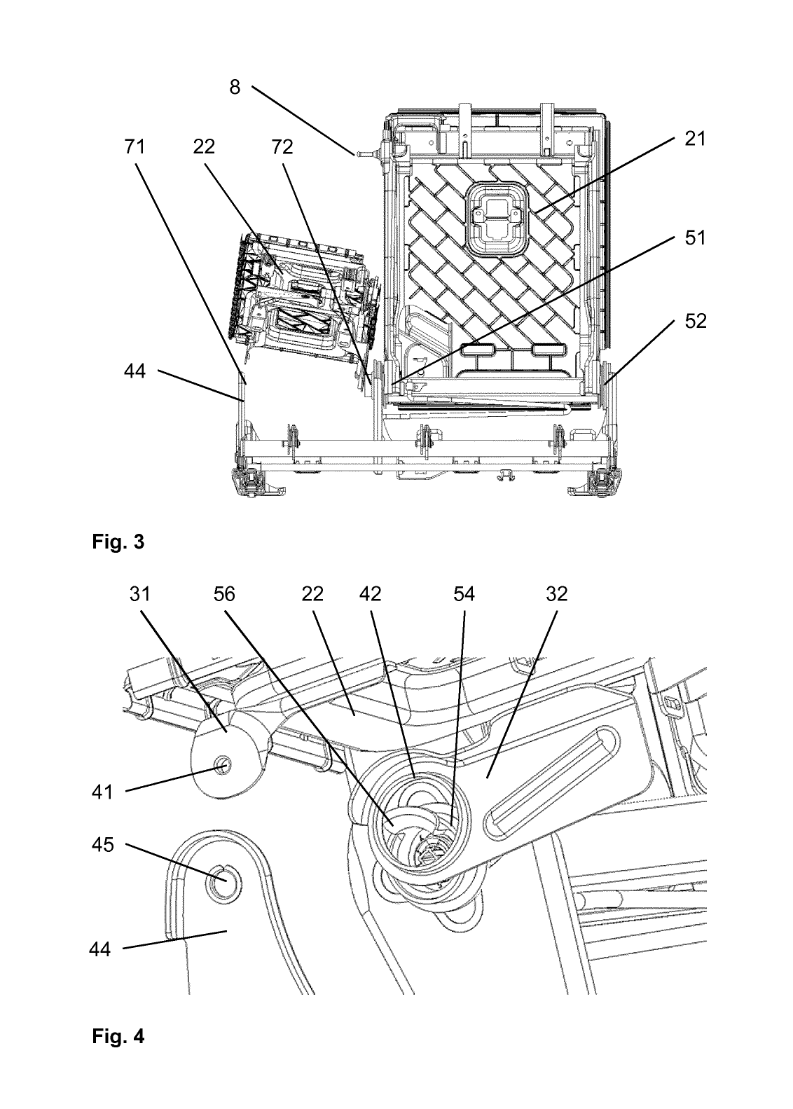

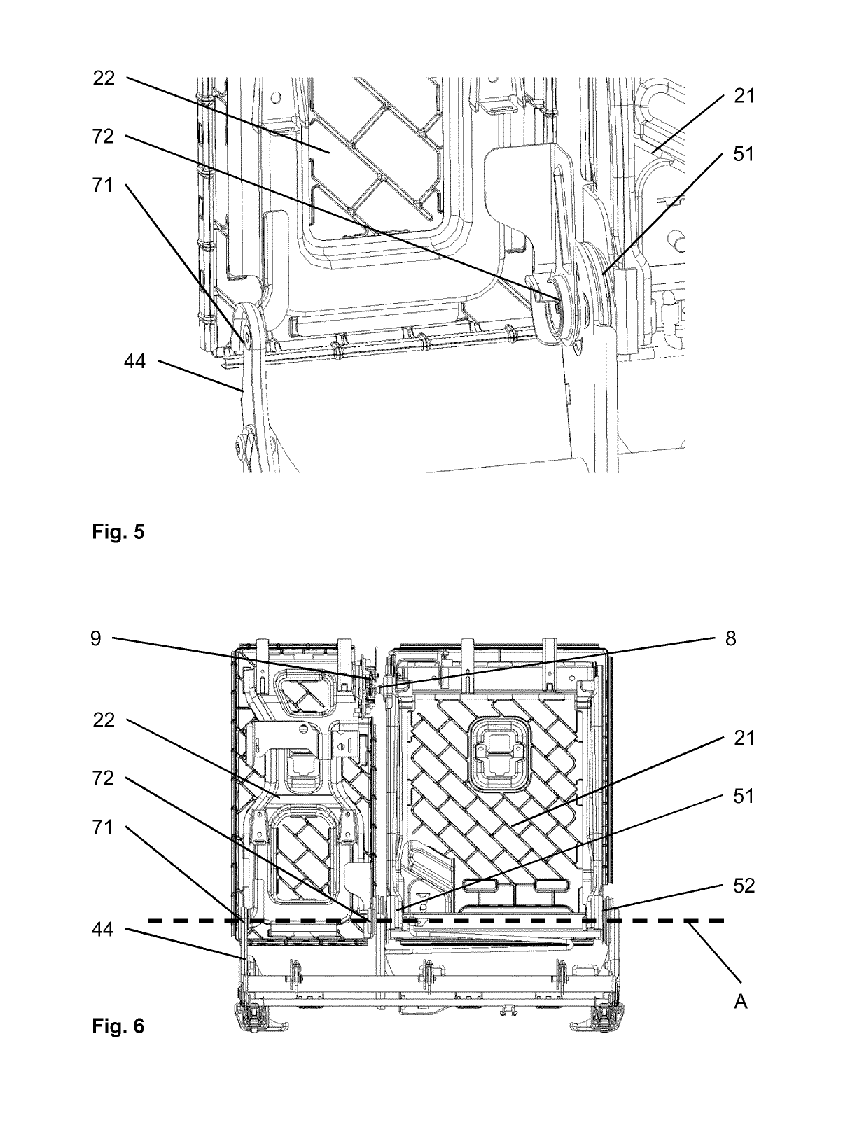

During mounting of the middle backrest 22, the latter is moved toward the left-hand backrest 21 with an orientation which is inclined, in relation to its later orientation, relative to the vertical direction and/or relative to the longitudinal direction, as can be seen in FIG. 3 and FIG. 4. In this case, the second pivot bearing opening 42 which is situated in the second side part 32 is pushed over the catching contour 56 onto the pivot bearing sleeve 54.

Subsequently, the middle backrest 22 is tilted about the longitudinal direction and/or about the vertical direction until the first pivot bearing opening 41 which is situated in the first side part 31 lies in a centered manner on the pivot axis A. Subsequently, the fastening pin 74 is guided through the through opening 45 in the lower part 44 and through the first pivot bearing opening 41 and is screwed to the pivot bearing opening 41 which has an internal thread.

FIG. 8 shows an alternative refinement of the second pivot bearing point 72.

A curved additional adapter 57 is attached, welded in the present case, to that fitting part of the first fitting 51 which is fixed on the seat part, which additional adapter 57 is passed through by the pivot axis A. A pivot bearing pin 58 of approximately rotationally symmetrical configuration is fastened to the additional adapter 57 in such a way that its center axis is aligned with the pivot axis A.

The internal diameter of the second pivot bearing opening 42 of the second side part 32 which is configured as a circular bore corresponds approximately, in this case, to the external diameter of the pivot bearing pin 58.

It is also conceivable to provide a sliding bush for mounting the second pivot bearing opening 42 on the pivot bearing pin 58. In this case, the pivot bearing opening 42 is adapted to the size of the sliding bush and is therefore larger than the external diameter of the pivot bearing pin 58. Furthermore, the second pivot bearing opening 42 can also be elliptical or can be configured as a slot instead of being circular.

According to a further refinement (not shown) of the second pivot bearing point 72, the latter comprises a transmission rod for actuating the first fitting 51. In this case, the transmission rod which connects the second fitting 52 to the first fitting 51 penetrates the first fitting 51 in the transverse direction. A two-piece bearing bush or ball bearing is mounted in a positively locking manner on that region of the transmission rod which penetrates the first fitting 51. The two-piece bearing bush or the ball bearing mounts the pivot bearing opening 42 of the second side part 32.

According to a further refinement (not shown here), the pivot bearing pin 58 is not fastened to the first fitting 51, but rather to a structure part of the first seat part 24.

A locking apparatus 9 which interacts with a locking pin 8 which is provided on the left-hand backrest 21 is arranged close to the upper end of the middle backrest 22, which upper end faces away from the pivot axis A. When the locking apparatus 9 is locked with the locking pin 8, the middle backrest 22 can be pivoted together with the left-hand backrest 21 relative to the first seat part 24. When the locking apparatus 9 is unlocked, the middle backrest 22 can be pivoted forward into the non-use position relative to the first seat part 24 independently of the left-hand backrest 21.

Each of the three seating positions has a three-point belt system, each three-point belt system comprising an inertia belt reel (not shown here). The inertia belt reels of the first seating position 11 and the third seating position 13 are fastened in each case to the vehicle structure. The inertia belt reel of the second seating position 12 is fastened to the left-hand backrest 21 of the first seating position 11. The inertia belt reel of the second seating position 12 is therefore likewise situated in the first seat segment 14.

The features which are disclosed in the above description, the claims and the drawings can be of significance both individually and in combination for the implementation of the invention in its various refinements.

While specific embodiments of the invention have been shown and described in detail to illustrate the application of the principles of the invention, it will be understood that the invention may be embodied otherwise without departing from such principles.

1. A vehicle seat having a seat segment comprising:
a first seating position with a first backrest
a second seating position with a second backrest;
a seat part, the first backrest and the second backrest being pivotable about a pivot axis relative to the seat part, and
a first fitting;
a second fitting, the first backrest being connected to the seat part by the first fitting and the second fitting, the fittings in each case having a fitting part which is fixed to the seat part and a fitting part which is fixed to the backrest, which fitting parts can be pivoted relative to one another, wherein the second backrest can be pivoted about the pivot axis by means of a first pivot bearing point which is configured as a locating bearing and by means of a second pivot bearing point which is configured as a floating bearing, and the second pivot bearing point comprises a pivot bearing sleeve which is fastened to the first fitting.

2. The vehicle seat as claimed in claim 1, wherein the first pivot bearing point comprises a fastening pin which engages through a lower part which is provided on the seat part and through a side part which is provided on the second backrest.

3. The vehicle seat as claimed in claim 1, wherein the pivot bearing sleeve is fastened to a fitting part of the first fitting which is fixed on the seat part.

4. The vehicle seat as claimed in claim 1, wherein the pivot bearing sleeve is fastened to a fitting part of the first fitting which is fixed on the backrest.

5. The vehicle seat as claimed in claim 1, wherein the pivot bearing sleeve is configured in the form of a hollow cylinder.

6. The vehicle seat as claimed in claim 5, wherein a cylinder axis, which is defined by the pivot bearing sleeve, is aligned with the pivot axis.

7. The vehicle seat as claimed in claim 1, wherein a catching contour is attached to the pivot bearing sleeve, which catching contour prevents releasing of the second backrest from the pivot bearing sleeve in the case of a crash.

8. The vehicle seat as claimed in claim 1, wherein the second pivot bearing point comprises a pivot bearing pin.

9. The vehicle seat as claimed in claim 8, wherein the pivot bearing pin is of rotationally symmetrical configuration.

10. The vehicle seat as claimed in claim 9, wherein a cylinder axis, which is defined by the pivot bearing pin, is aligned with the pivot axis.

11. The vehicle seat as claimed in claim 8, wherein the pivot bearing pin is fastened to the first fitting.

12. The vehicle seat as claimed in claim 1, wherein the second pivot bearing point has a transmission rod for actuating the first fitting.

13. The vehicle seat as claimed in claim 12, wherein a two-piece bearing sleeve or a ball bearing is mounted on the transmission rod.

14. The vehicle seat as claimed in claim 1, wherein the fittings are configured as latching fittings.

15. The vehicle seat as claimed in claim 1, wherein the fittings are configured as gear mechanism fittings.
